(19) United States
(12) Patent Application Publication
(10) Pub. No.: US 2021/0125290 A1
(43) Pub. Date: Apr. 29, 2021

(54) ARTIFICIAL INTELLIGENCE LOGISTICS SUPPORT FOR AGRIBUSINESS PRODUCTION

(71) Applicant: INTERNATIONAL BUSINESS MACHINES CORPORATION, Armonk, NY (US)

(72) Inventors: MARCELO MOTA MANHAES, Curitiba (BR); EDSON GOMES PEREIRA, Cotia (BR); GLAUCIO ALEXANDRE DE AZEVEDO, Jardim Chapadão (BR); Marcel de Toledo Pineda, Santo Andre (BR); DANIEL DE PAULA TURCO, Campinas (BR); TIAGO DIAS GENEROSO, Poços de Caldas (BR)

(21) Appl. No.: 16/666,476

(22) Filed: Oct. 29, 2019

(51) Int. Cl. G06Q 50/02; G06K 9/62; G06N 3/08; G06N 20/00

(52) U.S. Cl. CPC G06Q 50/02; G06K 9/6201; G06N 20/00; G06K 9/6289; G06N 3/08; G06K 9/623

(57) ABSTRACT

A method, a computer system, and a computer program product for an artificial intelligence (AI) based agribusiness logistics advisor is provided. Embodiments of the present invention may include receiving a first user data. Embodiments of the present invention may include collecting a second user data and external data. Embodiments of the present invention may include preparing and transforming the second user data and the external data. Embodiments of the present invention may include conducting a hypothesis on the transformed data. Embodiments of the present invention may include validating the transformed data. Embodiments of the present invention may include training an artificial intelligence (AI) model based on the transformed data. Embodiments of the present invention may include matching the first user data with the artificial intelligence (AI) model. Embodiments of the present invention may include ranking results based on the matching the first user data with the artificial intelligence (AI) model.

### BACKGROUND

The present invention relates generally to the field of computing, and more particularly to artificial intelligence. Global agribusiness logistics may not be efficiently utilized between buyers and farmers. Much of the agribusiness global supply may still be produced by small farms and small farms may be limited in terms of predictive capabilities and the abundance of information available to assist a farmer in maximizing crop products and reduce waste.

### SUMMARY

Embodiments of the present invention disclose a method, a computer system, and a computer program product for an artificial intelligence (AI) based agribusiness logistics advisor. Embodiments of the present invention may include receiving a first user data. Embodiments of the present invention may include creating a first user profile. Embodiments of the present invention may include collecting a second user data and external data. Embodiments of the present invention may include preparing and transforming the second user data and the external data. Embodiments of the present invention may include conducting a hypothesis on the transformed data. Embodiments of the present invention may include validating the transformed data. Embodiments of the present invention may include training an artificial intelligence (AI) model based on the transformed data. Embodiments of the present invention may include validating and retraining the artificial intelligence (AI) model. Embodiments of the present invention may include matching the first user data with the artificial intelligence (AI) model. Embodiments of the present invention may include ranking results based on the matching the first user data with the artificial intelligence (AI) model.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an example block diagram of the agribusiness logistic components according to at least one embodiment;

FIG. 3 is an operational flowchart illustrating a process for artificial intelligence (AI) logistics support for agribusiness production according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein, however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

As previously described, Global agribusiness logistics may not be efficiently utilized between buyers and farmers. Much of the agribusiness global supply may still be produced by small farms and small farms may be limited in terms of predictive capabilities and the abundance of information available to assist a farmer in maximizing crop products and reduce waste. Additionally, some products that do not meet a standard quality for one market may be used in a different market for a different purpose.

Many factors may create hardships for farmers, such as high product loss if issues arise, such as logistical, a lack of economic evaluations, a difficulty in finding buyers for products, weather evaluations or product quality. For example, if a farmer in a remote area has a fresh crop but has difficulty finding buyers, then a significant amount of the crop may not be utilized or wasted. If the farmer was provided with more information, the farmer could have more choices or options to sell, for example, high quality tomatoes to a gourmet market or lower quality tomatoes to a company that produces tomato sauce. The farmer may base this decision on a coefficient of perishability and then decide to stock the product, sell the product or donate the product to the community.

Additionally, with global competition for farmers, a disadvantage to some farmers may include having the ability to show products to buyers and negotiate. Agribusiness consists of a complex global environment such that the product quality and the amount of product available may be constantly in flux based on economic factors, weather factors, transportation factors or road conditions. These factors are interconnected, and farmers do not have available access to the information that could affect their production. Therefore, it may be advantageous to, among other things, dynamically collect, analyze and predict the interconnected factors and provide analyses and predictive capabilities to farmers.

The following described exemplary embodiments provide a system, a method and a program product for dynamic artificial intelligence (AI) based agribusiness logistic solutions. As such, embodiments of the present invention have the capacity to improve the field of agribusiness-based AI by creating a system, method and program product to assist farmers in dynamic changes that affect their crops. More specifically, and without requiring a demanding investment in equipment to a small farmer, an agribusiness logistics program identifies and analyzes factors to assist the farmer in harvesting crops with higher efficiency, less waste, product stocking management and predictive foresight in buyers looking for their particular products. Instead of crop products going to waste, a farmer may be provided with information to allow for contingency plans and adjusting based on unexpected factors or events, such as economic changes, weather changes, governmental shifts, legal changes or logistical changes, further allowing the farmer to identify buyers quickly. The end customer or consumer may gain the benefit of fresh products at lower prices since less waste will assist the global economic supply versus demand structure.

Additional benefits may include reducing transportation time by recommending a best transportation method based on, for example, road conditions, traffic or storms affecting the shipping, land or air transport routes. Improved economic impacts may include considering and analyzing local or county news to recommend selling to local buyers or to export products. Weather predictions may help farmers in preparing crops for fluctuating conditions. Another benefit may include information that allows a farmer to quickly locate the best buyers or the buyers looking for a current produce or harvested crop from a farmer. AI and machine learning (ML) models may be built to recommend potential buyers to farmers and farmers to potential buyers based on product quality, product quantity and timing of each harvest.

Further advantages include a scenario such that if the production exceeds the expected volume, a farmer may have the ability to quickly identify other buyers, which will significantly reduce product loss or waste. Buyers and farmers may also have the ability to purchase and sell directly, which streamlines the time period in between the time the product is ready and the time the product reaches the end consumer. Streamlining the time period also provides the end consumer with fresh products. Smart analytics models and optimization algorithms may analyze factors such as perishability. A perishability coefficient may be used to allow a farmer to make decisions relating to storing a product, selling a product or donating a product to a local community.

According to at least one embodiment, various data is collected for the purpose of performing data analytics, deep analysis, building ML models and building AI models. The collected data may include historical data and current real-time data. Historical data may be collected by access to repositories, databases, knowledgebases or corpora, either public access or private access if proper access is granted. Real-time data may be collected continuously and become historical data for reference, for example, from databases relating to transportation routes, transportation costs, traffic, weather, product quality, product price, news, articles, blogs, local events or global events. Additional data may be collected and used for analysis from, for example, internet of things (IoT) devices and sensors, smart phones, smart watches, smart tablets, automotive devices or personal computers. For example, data collected by a user A, such as a farmer using a personal computer, and a user B, such as a buyer using a smart phone, may be collected for analysis.

According to an embodiment, for real-time data being collected and accessed, such as user preference data, user profile data or external source data collected form a user, the data may be transmitted to and received by computing devices by receiving consent from the consumer, via an opt-in feature or an opt-out feature, prior to commencing the collecting of data or the monitoring and analyzing of the collected data. For example, in some embodiments, the consumer may be notified when the collection of data begins via a graphical user interface (GUI) or a screen on a computing device or smart phone. The user may be provided with a prompt or a notification to acknowledge an opt-in feature or an opt-out feature.

According to an embodiment, the collected data may be used for analyses and to build AI and ML models. The analysis, AI and ML models may be used to predict and analyze factors to assist the farmer in harvesting crops with higher efficiency, less waste, more predictive foresight, a reduction of costs and a minimized risk. Various types of models may be built to create predictive results for users related to agribusiness, such as farmers, buyers, end consumers, logistics companies or storage and warehouse companies. Models may also include deep learning models using neural networks. Training and updating a ML model may include supervised, unsupervised and semi-supervised ML procedures. Supervised learning may use a labeled dataset or a labeled training set to build, train and update a model. Unsupervised learning may use all unlabeled data to train a deep learning model. Semi-supervised learning may use both labeled datasets and unlabeled datasets to train a deep learning model.

Supervised learning and semi-supervised learning may incorporate ground truth by having an individual check the accuracy of the data, data labels and data classifications. Individuals are typically a subject matter expert (SME) who have extensive knowledge in the particular domain of the dataset. The SME input may represent ground truth for the ML model and the provided ground truth may raise the accuracy of the model. The SME may correct, amend, update or remove the classification of the data or data labels by manually updating the labeled dataset.

According to an embodiment, supervised or semi-supervised ML may be used to allow an individual (e.g., a user, a SME, an expert or an administrator) to have some control over the model by having the ability to validate, alter, update or change the training set. SMEs may provide input or feedback into a model by altering the training set as opposed to an unsupervised model environment, when the SME may not provide input to the data.

Various cognitive analyses may be used, such as natural language processing (NLP), semantic analysis and sentiment analysis during the model building and training. The cognitive analytics may analyze both structured and unstructured data to be incorporated into the model process. NLP may be used to analyze the quality of data, feedback or a conversation based on the received data. Structured data may include data that is highly organized, such as a spreadsheet, relational database or data that is stored in a fixed field. Unstructured data may include data that is not organized and has an unconventional internal structure, such as a portable document format (PDF), an image, a presentation, a webpage, video content, audio content, an email, a word processing document or multimedia content. The received data may be processed through NLP to extract information that is meaningful to a user.

Semantic analysis may be used to infer the complexity, meaning and intent of interactions based on the collected and stored data, both verbal and non-verbal. For example, verbal data may include data collected by a microphone that collects the user dialog for voice analysis to infer the emotion level of the user. Non-verbal data may include, for example, text-based data or type written words, such as a social media post, a public service announcement, collaborator data communication, a text message, an instant message or an email message. Semantic analysis may also consider syntactic structures at various levels to infer meaning to words, phrases, sentences and paragraphs used by the user.

Sentiment analysis may be used to understand how communication may be received by a user or interpreted by the user. Sentiment analysis may be processed through, for example, voice identifier software received by a microphone, facial expression identifier software received by a camera or biometric identifier software received by an augmented reality device, a smart phone or a wearable device such as a smart watch. Sentiment may also be measured by the tone of voice of the individuals communicating and the syntactic tone in type-written messages, such as a social media post, a text message or an email message.

According to an embodiment, the collected data may be analyzed to build a model that provides recommendations to users, such as farmers, relating to potential buyers considering crop harvest timing and products harvested. The recommendations may be based on the product quality and price as the crop harvest timing and products may be related to weather patterns, news, current events or a coefficient of perishability. The model may also predict, identify or analyze the best transportation method based on a location of the farm, the location of the recommended buyer, the weather forecast for when the transportation may be occurring, road conditions, traffic conditions, airline or flight conditions or shipping, cargo or freight conditions.

According to an embodiment, both farmers and buyers may be considered users of the created ML and AI models. Going forward, farmers and buyers will be called their respective names for the purposes of the use case provided using farmers and buyers, however, both may be considered users. Farmers may create a profile using information, such as current crop and harvest data, a location, cultivated areas, products, the quality of the harvest and products, an expected date that the crop may be ready for harvesting, a sell price and current agreements.

According to an embodiment, the buyer may input data parameters, such as the buyer's location, products of interest, product quality expected, expected date to receive the products, the volume of product and a price for the product. The model may include a predefined set of parameters, such as semantic features associated with the each user's input in addition to news articles relating to the location, the country, the economy, scientific articles, current highway conditions, predicted highway conditions and forecasts, railway conditions, current weather forecasts, predicted weather forecasts and public service announcements.

The model predictions may utilize the user input data, SME data and the collected external real-time and historical data to predict and make suggestions to users, such as farmers, buyers and farmers who may also be buyers. The predictions and suggestions provided by the models may be stored and the models may be continually retrained based on user feedback and the external data collected. The predictions and suggestions may provide guidance to users that may be best suited to purchase the products without having to invest heavily into equipment and technology. For example, the farmer's input on a personal computer, the buyer's input on a personal computer and the trained model, such as the agribusiness logistics program, may be a sufficient amount of investment for the farmer to receive the recommendations. Additionally, the recommendations may change over time, thus, creating continually retrained and updated models for the users to allow the users to make quick and accurate decisions.

A use case example may include a farmer who has to plan out the entire year of harvesting crops. The plan may ensure the conditions are optimal to stay in the market and deliver quality products to buyers that will ultimately reach end users or consumers. Crops that may be produced on the farmer's property include rice, arabica coffee, corn, tomato and lettuce. The farmer has chosen to concentrate his harvests on these 5 cultures or products by considering the climate and the location aspects of the farmer's property. The farmer will also be considering how much to invest for the harvests for the following year. Some of the products are purchased by a buyer who sells products to large companies, some of the products are exported and other portions of the products are sold to internal markets that are closer in location to the farm. An example of crop transportation options is shown in Table 1.

TABLE 1

| | Truck | Train | Boat | Van or Car |
|---|---|---|---|---|
| Rice | x | x | x | |
| Arabica Coffee | x | x | x | |
| Corn | x | x | x | |
| Tomato | x | | | x |
| Lettuce | x | | | x |

As the production needs, supply and consumer demands shift, logistical issues may arise that can impact the product quality and price. Additional issues may include finding new buyers or consumers outside of the surrounding farm location if the supply and demand shift occurs. Without the ability to seamlessly shift product transportation when logistical, supply or demand issues happen, much of the harvested crop may spoil and be wasted. Waste may still occur even if much of the crop is donated to local citizens. Additionally, the location of the farm may be near a river, however, the river may not be a viable source of transportation, thus, creating an infrastructure gap by needing transport via trucks, vans or cars. If the production is highly perishable, then locations closer in proximity may be ideal for particular harvests.

With the changing landscapes of each farm and different varieties of quality products available in different regions, an agribusiness logistics program may allow users a wider reach to sell and purchase products globally, thus further serving the consumers in their respective markets with more variety and higher quality products.

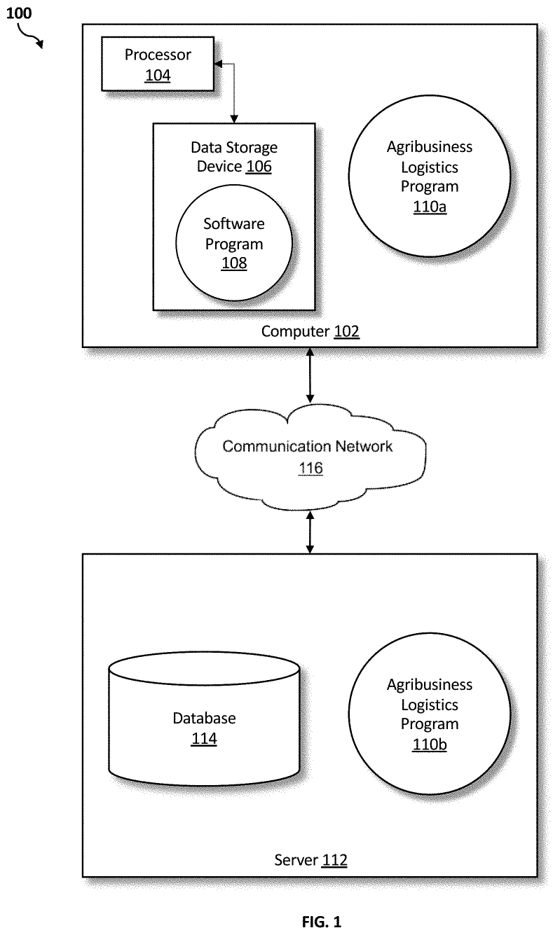

Referring to FIG. 1, an exemplary networked computer environment 100 in accordance with one embodiment is depicted. The networked computer environment 100 may include a computer 102 with a processor 104 and a data storage device 106 that is enabled to run a software program 108 and an agribusiness logistics program 110a. The networked computer environment 100 may also include a server 112 that is enabled to run an agribusiness logistics program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

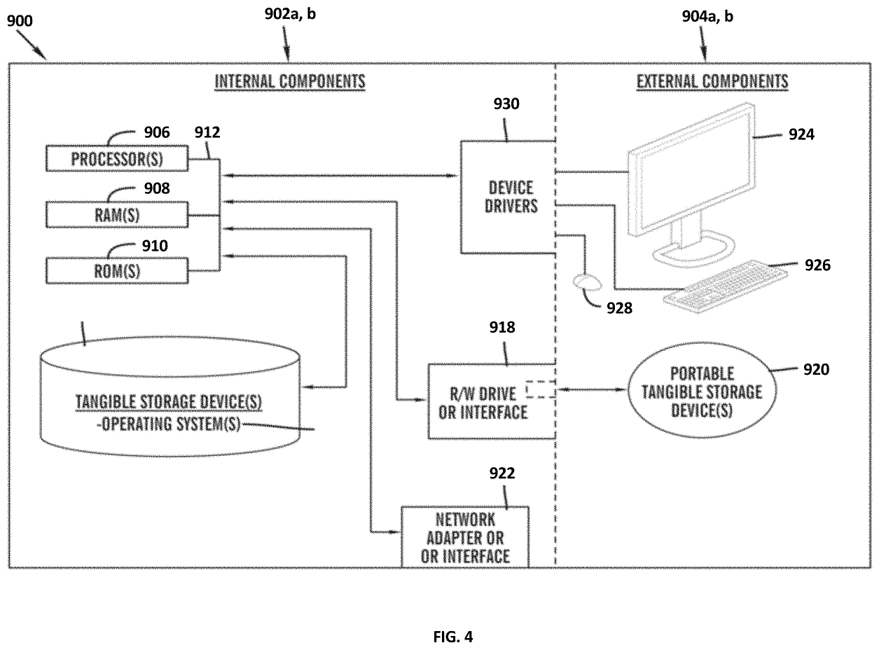

The client computer 102 may communicate with the server computer 112 via the communications network 116. The communications network 116 may include connections, such as wire, wireless communication links, or fiber optic cables. As will be discussed with reference to FIG. 4, server computer 112 may include internal components 902a and external components 904a, respectively, and client computer 102 may include internal components 902b and external components 904b, respectively. Server computer 112 may also operate in a cloud computing service model, such as Software as a Service (SaaS), Analytics as a Service (AaaS), Blockchain as a Service (BaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the agribusiness logistics program 110a, 110b may interact with a database 114 that may be embedded in various storage devices, such as, but not limited to a computer/mobile device 102, a networked server 112, or a cloud storage service.

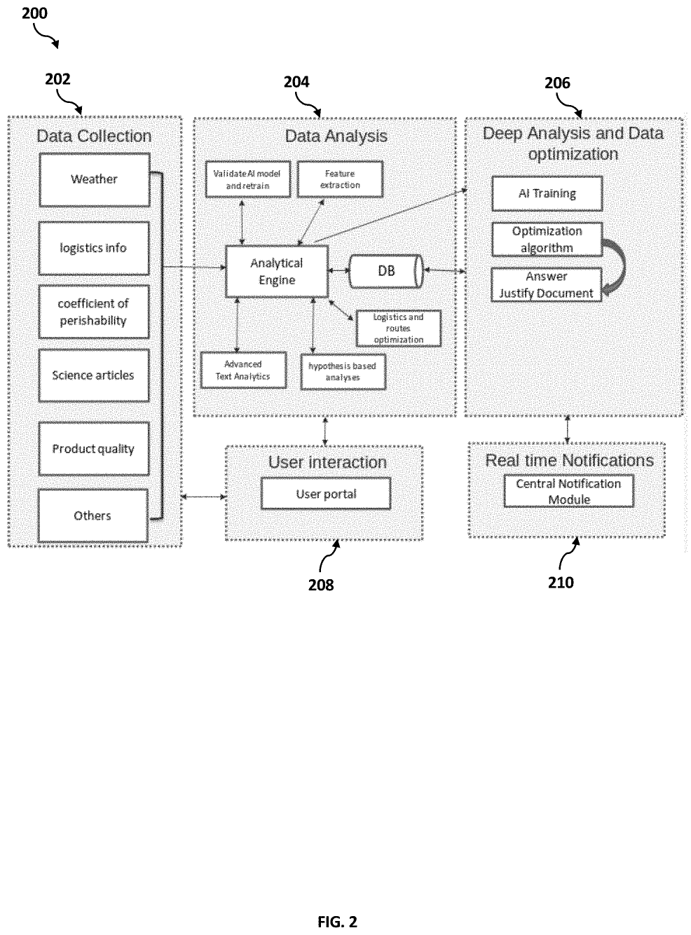

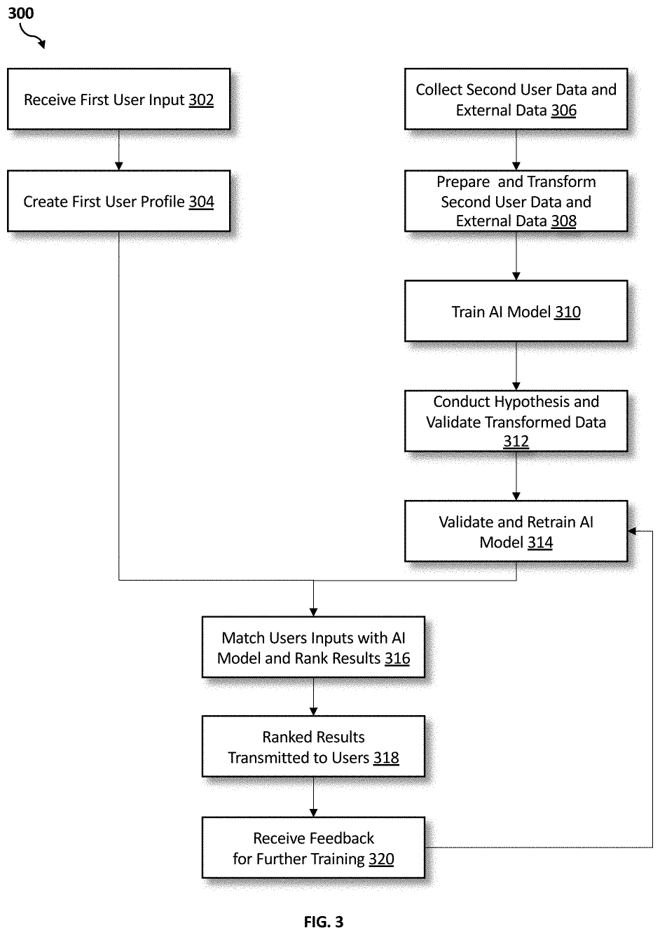

According to the present embodiment, a user using a client computer 102 or a server computer 112 may use the agribusiness logistics program 110a, 110b (respectively) to receive logistic support using AI models and ML models. The agribusiness logistic method is explained in more detail below with respect to FIGS. 2 and 3.

Referring now to FIG. 2, an example block diagram of the agribusiness logistic components 200 used by the agribusiness logistics program 110a, 110b according to at least one embodiment is depicted. The agribusiness logistic components 200 block diagram may represent a large scale component integration of five main components, a data collection 202 module, a data analysis 204 module, a deep analysis and data optimization 206 module, a user interaction 208 module and a real-time notifications 210 module.

A data collection 202 module may include collecting historical and current information from various sources and databases to build AI and ML models, such as databases relating to the weather, logistics, coefficient of perishability, science articles, product quality and others. Data collection 202 may also be obtained from end consumers, social media data or IoT devices and sensors. A data analysis 204 module may receive information from various sources, such as the data collection 202 module and a user interaction 208 module, to prepare the received data from the multiple sources for further processing and model building.

The data analysis 204 module may include an analytical engine that runs cognitive analytics, such as NLP, semantic analysis and sentiment analysis based on the received data from the data collection 202 module and the user interaction 208 module. The data analysis 204 module also includes a module that validates and retrains the built models, a feature extraction module, an advanced text analytics module, a hypotheses-based analysis module, a logistics and routes optimization module and a database to store, train, validate and retrain AI an ML models.

A deep analysis and data optimization 206 module may include an AI training module, an optimization algorithm and an answer justify document (AJD). The AI training module may train and further improve the analysis received from the data analysis 204 module. The user interaction 208 module may include a user portal. The user interaction 208 module may receive user entries and profile information from one or more users, such as a farmer and a buyer to create the user profile. The user interaction 208 module may also receive information from subject matter experts (SMEs) or data science professionals to improve the data efficiency and to further train the models using ground truth.

A real-time notification 210 module may include a central notification module. The real-time notification 210 module may notify a user of changes to an analysis, such as abrupt changes of an analysis, market changes and logistical notifications transmitted to the user.

Referring now to FIG. 3, an operational flowchart illustrating the exemplary AI logistics support for agribusiness production process 300 used by the agribusiness logistics program 110a, 110b according to at least one embodiment is depicted.

At 302, a first user input is received. The first user input may include data that will be used to create a profile identification, for example, a farmer providing information to create a farmer profile identification. The user input for the farmer may include personal data, such as an address or location of the farm, information relating to current contracts with buyers or partners, the types and the volume of crop products planned to harvest for the next specified or estimated number of seasons. The farmer may also input projected costs and projected profits.

The first user may have required fields and optional fields in which to enter information to create the profile identification. Additional fields may include, for example, a name, a company name, a company address, an initial budget, locations of additional farms, farm equipment, farm resources and employee information, such as how many employees. The first user data is stored on a database or knowledgebase. The more data that is input by the first user, the better the models may perform and predict optimal options to the farmer relating to the supply chain.

Optional additional data that may be collected may also include technical information relating to the farm atmosphere that may assist in measuring quality and timing for products for a buyer. The optional additional data may include, for example, soil mixture data obtained by an IoT devices, types of soil products used for farming, pH values of the soil, weather conditions, topology and geology information from a map application. Map application data and IoT devices may produce additional data, such as, a GPS latitude, a GPS longitude, a GPS altitude, a minimum temperature, a maximum temperature, an average temperature, a soil PH value, electrical conductivity, a percentage of exchangeable sodium, atmospheric or barometric pressure or a current or average wind speed. Weather condition data may include average minimum and maximum temperatures and average precipitation for each month of the year. Property zoning and land size data may be obtained via public records as additional data.

At 304, the first user profile is created. The first user input collected at step 302 and the optional additional data collected may be used to create a first user profile. The first user input and the additional data is combined and stored on a repository for each first user, such as the farmer. Each user may have varying amounts of collected data based on the user location, the farm location, city, state, country or types of crops harvested. The profile for each user is stored for future matching of profile data with the predictive results from the built and trained models.

At 306, a second user data and external data are collected. The second user data may be collected from, for example, the buyer. The buyer data may include parameters relating to what the buyer is seeking to purchase from a farmer. Buyer data may include the buyer's location, products of interest, product quality expected, expected date to receive the products, the volume of product and a price expected to pay for the product.

External data may be collected using web crawlers or bots to collect information and information dimensions relating to external factors from databases relating to the weather, logistics, coefficient of perishability, science articles, product quality, public services, agriculture news, financial news, logistics, scientific data, current global events or collaborator data from supply chain agriculture advisors. Information dimensions may represent each source that a web crawler collects data from. Each dimension or source may include sub-dimensions. For example, scientific articles may be one dimension for each different type of harvest that a farmer may cultivate, such as sub-dimensions of rice, wheat or soy. The collected external data may be obtained in structured (e.g., database tables) or unstructured formats, such as HTML, images, word processing documents, text files or PDF documents. Each dimension may also have separate sets of data, such as cost, profit or risk for each sub-dimension.

External data may also include SME data. SME data may provide subject matter and regional expertise in terms of data classifications, labels and definitions. SMEs may be used to define parameters and annotate data. SME data may advance the analytics by, for example, further clarifying datasets classifications related to NLP analysis, sentiment analysis, semantic analysis or relationship extraction analysis as ground truth for the machine learning process.

The SME may support the model learning process, supervised or semi-supervised machine learning, by assisting in building an ontology by translating language definitions for particular regions, dimensions and websites. The SME may be a local resident or an expert in science, meteorology for weather expertise, legal structures, government structures and laws relating to farms, labor, trade or resources, economic and finance structures, agriculture, logistics or global transportation.

At 308, the second user data and the external data are prepared and transformed. The second user data and the external data may be prepared and transformed using the same process, as the data may be received or collected in both structured data forms and unstructured data forms. For each set of data to be prepared and transformed, such as data collected from the second user or a weather website, a current event website, a public service announcement website or a scientific journal website, a web crawler may wrangle the data to integrate the data from several of the data sources, corpora, databases or knowledgebases. Wrangling data may include the process of collecting the data by crawling the data from web-based sources. The data may be normalized in order to consistently merge the data from multiple datasets. The data may also be parsed into structured data or both forms of structured data and unstructured data and may be stored for further use.

For example, structured data is used for AI models and unstructured data is used to define an answer justifying the documents (AJDs) relating to future alert dashboards and for support of a hypothesis. Feature extraction functions may be used to gather relevant information for dashboards in the format of answer justifying documents (AJDs). The collected data may be used for an answer justifying document (AJD) processor for a final dashboard result display to justify decisions made by the model algorithms. The answer justifying document may, in addition to advice relating to the optimal supply chain options, provide reasoning that supports the advice.

Sources may be defined based on information being crawled based on each dimension. Data wrangling may identify, collect, merge and process one or more datasets in preparation for data cleansing. The feature extraction may be trained and defined, for example, using rule-based features for each dimension. The functionality feature extraction feature may, for example, extract features using NLP and rule-based techniques for each dimension and provide an output in a comma-separated values (CSV) format.

During preparation, the data may then, for example, be converted to be used for data analytics and to train AI and ML models in a format such as a comma-separated values (CSV) format or a JavaScript object notation (JSON) format. Once converted, the data may become a training dataset for the AI and ML models.

The training dataset may be cleansed or repaired for inconsistencies, missing values, insufficient parameters or incorrect delimiters, for example, in the CSV format. Cleansing the data may include a process of detecting and correcting, or removing, corrupt, invalid or inaccurate data. If the data cannot be repaired, then the section of data that cannot be repaired will be removed. Once the cleansing and syntactic checking has been accomplished, a semantic check will be accomplished by checking for outliers or for outlier verification. Outlier verification may include an alternative approach to fault detection based on limit checking with constant or linear thresholds. Training datasets may be created for different domains or dimensions, such as a risk training dataset, a profit training dataset, a current events training dataset, a scientific training dataset or a resource and production cost training dataset, a social demand or social media dataset or a weather condition dataset.

The data preparation process may now be transformed, such as normalized, to transform the categorical data into numerical values to build a more efficient model that produces a higher amount of predictive accuracy by using hot encoding techniques. Since each dimension can produce different types of data sources with differing formats, differing languages, and from differing regions, the cleansing and normalizing to use hot encoding techniques, by a hot encoder, provides greater accuracy during the training phase of the model learning process. Cleansing and preparing may be executed on each data dimension.

The hot encoder may be used for advanced text analytics, such as adding additional columns to account for added dimensions to train the machine learning model for enriched validation inside the text. Enriched validation may include, for example, adding new columns for dimensions that will improve the model. Additionally, when the data preparation analyzes an external source, such as an economic news database for rice crops, then the enriched column may be considered the sentiment analysis of the economic news dimension. Additional columns may include NLP or SME added economical sentiment, weather sentiment or social demand relating to products. Data curation may also be used to ingest the data and convert the data to a standard format, enrich the data using semantic analyzers and normalize the data.

Additionally, advanced text analytics may transform data from discrete categories to continuous values and provide semantic checking that may include data conversions and calculations for transport routes. The advanced text analytics may enrich the data by capturing text values on each dimension, for example, breaking news or public service announcements, and may not capture the text about the news but may capture the sentiment, such as tone, relations and confidence of the information source. For example, the particular dimension that the advanced text analytics is analyzing may feed the data that is prepared to be an additional column (i.e., operational variable) for a news AI model relating to risk, cost, waste and profit. A SME may also provide additional data relating to the source of the information.

A data preparation example using an economic dimension for AI input models may provide multiple scorings for different types of coffee and may produce an output profit table and an output risk table. Each table may not require the same input for each AI model based on each dimension. For example, the profit table and the risk table for producing different types of coffee may have a break risk coefficient and a classification column produced from different sources but may be viewed as a continuous value. In addition to many other values or columns that can be provided on a table, such as variety, price per bag, variation or multiple new tones, Table 2 highlights other column values and the seamless continuous values related to profit and risk. See Table 2.

TABLE 2

| | | | | | |
|---|---|---|---|---|---|
| | | | News | Site | |
| | | News | Tone | Con- | Class- |
| Product | Type | Sentiment | Analytical | fidence | ification |

Profit

| | | | | | |
|---|---|---|---|---|---|
| Coffee | Arabic | −0.78 | 0.84 | 2 (high) | −0.80 |
| | | (negative) | | | (negative) |
| Coffee | Robusta | 0 | 0.80 | 2 (high) | 0.6 |
| | | (neutral) | | | (positive) |

Risk

| | | | | | |
|---|---|---|---|---|---|
| Coffee | Arabic | −0.08 | 0.75 | 2 (high) | 0.10 |
| | | (neutral) | | | (neutral) |
| Coffee | Robusta | −1 | 0.40 | 2 (high) | −0.99 |
| | | (negative) | | | (negative) |

An alternate embodiment may include an additional step to preparing the data that may include processing logistic data and partner data during the preparation of data phase. Processing the logistic data and the partner data may include, for example, preparing the data to be delivered to an AI or ML model for all routes to reach each partner or buyer and the risk versus profit weights in terms of positive, neutral or negative classifications for the routes.

In the alternate embodiment, the data being received for preparation and processing may be continuous and, therefore, continuously changing and updating based on the data received relating to the routes, partners, buyers, logistics, weather, street conditions, traffic conditions or the inclusion or exclusion of buyers. The supply chain options may, therefore, be captured and provided as options for product delivery on a regular basis, on predetermined time intervals or when a supply chain option suddenly shifts. The complexity of the continuous data updates and changes may, for example, use an algorithm with a nondeterministic polynomial-complete (NP-complete) that includes nondeterministic polynomial (NP) and nondeterministic polynomial-hard (NP-hard) complexity classes. Additionally, based on the complexity, a quantum computing module may be used to optimize the supply chain routes.

Initially, routes may be mapped using different sources, such as regulatory agencies, supply chain locations or buyers' inputs in logistics and routes optimization controls. After the initial data curation, a computing optimization algorithm may be applied to discard, include or optimize routes. The buyer input data may be used to calculate the routes, the logistics and the cost for each option. The result provided to a buyer, a partner or a farmer may provide a map by region in a table with logistics, routes, partners and perishable dimensions from a source to a destination. The resulting data obtained from the logistics and routes optimizations may also define a coefficient of route quality (i.e., neutral, negative or positive) for preparing the data for a profit and risk AI model training.

The data preparation phase may include consolidating, processing and analyzing the received and collected external and buyer data by, for example, crop, product, variety and region for each dimension. The consolidated data may have been cleansed to remove duplicated data before the AI or ML training phase.

At 310, an AI model is trained. A model training phase may also include ML model training. The prepared and transformed data received from step 308 may be used to train one or more models. The model may be trained using neural networks and deep learning techniques to create a model to predict, for example, support for farmers, buyers and the agribusiness logistics and supply chain. Supervised and semi-supervised learning may be used to train the model to incorporate SME input and expert training. The SME input may provide added information from the wrangling phase in step 308 that may improve the quality and refine the feature selection to build and train the model. For example, the model is trained to predict if a farmer should plant a certain crop based on buyer contracts, buyer demand, perishability, logistics and route optimizations. The prepared data may be used to initially train the model and SME input may be used to further refine the model.

The training model output may include coefficients for each dimension, for example, a profit model for the economy dimension, a risk model for the economy and news dimensions, and the process of adding coefficients based on the dimensions. Therefore, the received and prepared data may continue to with training the model until all of the coefficients are collected. The model may be trained, for example, using a logistic regression algorithm or a neural network with back propagation depending on the number of features on each dimension.

At 312, hypotheses are conducted, and the transformed data is validated. Hypotheses may be conducted to build scenarios based on, for example, the logistics and perishability of certain crop products based on the farmer data, the buyer data and the external data. For example, answer justified documents (AJDs) may be used with the advanced text analytics to conduct hypotheses as in Table 3.

TABLE 3
Perishable

| | | | | Perish- |
|---|---|---|---|---|
| | | | Destin- | able |
| Product | Type | Region | ation | Risk |
| Coffee | Arabic | City A | Port of | 0.78 |
| | | | City B | (high) |
| Coffee | Robusta | City C | Port of | 0.08 |
| | | | City D | (low) |

Logistic

| | | | | | Final |
|---|---|---|---|---|---|
| | | Destin- | | | Class- |
| Product | Type | ation | Cost | Amount | ification |
| Coffee | Arabic | Port of | $2,000 | 10.00 | 0.14 |
| | | City B | | | (neutral) |
| Coffee | Robusta | Port of | $2,500 | 12.00 | −0.46 |
| | | City A | | | (negative) |

The conducted hypotheses may be used to validate and merge conflicting data, such as if one region states a negative sentiment relating to one product and the same region has a positive sentiment associated with a different product, then verification will be used to verify the source information and reliability. Upon verifying the source information and reliability of the data, the information may be kept or discarded by the less reliable source. The less reliable source may have a lower score associated with the information. The score of each source for each dimension may be defined, for example, by a SME. The output for conduced hypothesis and validation may include a dataset containing the analyzed dimensions.

As stated previously, a model may be trained, for example, using a logistic regression algorithm or a neural network with back propagation depending on the number of features on each dimension. Additionally, a hypothesis function on each dimension may be calculated, such as for a profit or risk model and may deliver continuous values between 0 and 1, such as 0<=h(x)<=1, where h represents a hypotheses and x represents the features as the input variables. The hypotheses may represent the coefficients that will be used later in an optimization function. Each hypothesis result may be an entry for a consolidated model for profit and risk.

A consolidated model may be a linear regression that receives input from a model for dimensions, such as economic, weather or logistic in a coefficient value and the output may include the optimal price to sell the crop harvest products. The consolidated model for risk may also be a logistic regression that receives input from a model for dimensions, such as economic, weather or logistic in a coefficient value and the output may be a risk classification in a function h(x) in a continuous range between 0 and 1. For example, a profit coefficient value may be based on

θ^{T}x,

where θ represents the coefficients provided by the AI dimension models, T represents the transpose matrix of coefficients and x represents the crop or harvest inputs from the farmer. An example of a risk classification as a function of h(x) may be based on

$$\frac{1}{1 + {e}^{- {θ}^{T}} x} ,$$

where e represents an exponential function.

For example, a risk hypothesis function with a value of h(x)>=0.7 may be considered high, between 0.3<h(x)<0.7 may be considered medium and h(x)<=0.3 may be considered low.

Training the consolidated model for dimensions, such as profit and risk, may include organizing the hypothesis in terms for answer justifying documents (AJDs) and validating the accuracy, the coverage and the precision of the model until the model is ready to match with a farmer profile.

At 314, the AI model is validated and retrained. AI model may be validated, retrained and tested using datasets may be implemented using both trained sets of data and new sets of incoming current data. Machine learning, such as using a neural network model, may be used to validate and test the transformed and validated data. Machine learning validation may be used to calibrate the model to combine layers in the neural network and the test set of data may validate against a normalized accuracy, such as using F1 score, precision and recall.

The F1 score may include a measurement to gauge prediction performance by using a binary classification and measuring the accuracy, precision and recall. The F1 score may be a compound metric of the precision and recall. The precision may include a data query relationship between relevant data and retrieved data such that the number of correct relevant data results may be divided by the total number of retrieved data results. Recall may include a data retrieval relationship between the total retrieved data and the successfully retrieved data such that the recall is the number of correct data results divided by the number of results that should have been provided. The compound metric, F1, also known as the F-score, the F-measure and the F1 score, measures accuracy using precision and recall such that the value of 1 is the optimal value of the harmonic average between the precision and the recall and 0 is the least optimal value.

AI models at each dimension may be trained, tested and validated, for example, as blind sets and based on SME input. A blind set may include, for example, a set of annotated documents used for model testing. At each dimension, if the performance meets a predetermined threshold of accuracy, such as 80% of precision, recall or F1 score, then the model may be validated. If the predetermined threshold of accuracy is not met, then the model may be retrained and more SME input may be used until the model is ready for use, for production use.

AI model calibrating on a testing dataset may be used to get the best possible precision measure. The precision measure may be instrumental in deciding a risk measure. Calibrating the testing data may include a process to improve the precision with further testing and validation loops by analyzing mistakes in predictions.

At 316, the users inputs are matched with AI models and ranked results. Matching, for example a farmer's inputs and profile with the built models may provide optimal predictions for the farmer and other users by listing the results in a ranked format. A ranked format may go from the least amount of risk to the highest amount of risk or the highest level of profitability to the lowest level of profitability. The ranked results may be matched based on predictions to a farmer, a buyer or a new user.

The precision measure at step 314 may assist in deciding the risk measure, which is used to match the AI model output with the user profiles. The agribusiness logistics program 110a, 110b, may match the users, for example, the farmer profile with the buyer input and the model predictions and then provide ranked the results. The user profile may be analyzed by transforming the user profile data into a machine learning model format, such as a comma-separated values (CSV) format or a JavaScript object notation (JSON) format. An optimization model, such as a Bayesian optimization, may be used to compare the alternatives to be ranked considering the risks to the user. The alternatives may include all possible outputs and then the outputs are ranked.

After ranking, an optimization model may use the profit and risk constraints and compare them with the contracts already accepted by the farmer from the buyers. The optimization model may then provide the farmer with the best alternatives for the products that are unaccounted for to be sold to other specified customers or buyers. The optimization model may use, for example, linear programming after receiving predictions from profit and risk models to optimize the responses received by the profit and risk models to the farmer based on the farmer's objectives.

For example, the optimization model may be composed of two modules. A first module may maximize profit and a second module may minimize risk. The optimization model may use a dual simplex model with constraint functions, such as the amount of capacity produced for the farmer for certain crops. The objective is to calculate the amount of profit that is allowed to be maximized. The coefficients of a linear function may include the price suggested for each farmer's crop based on an AI profit model. The variables may include the amounts of the product or crop to sell and may be described in a mathematical linear function (i.e., an objective function) with a brief description of the constraints. For example, all dimensions have an AI model for profit calculation and an AI model for risk measure. Partial results from each AI model may be used by the optimization engine to maximize profits and minimize risk. The results from the optimization engine may be ranked and provided to the user on an application dashboard on the user's smart phone or computer. The dashboard may provide the farmer with options to sell products in terms of amount, projected profit and risk associated with each choice or decision. An explanation may also be provided to support the hypotheses associated with each choice or decision.

The module to minimize risk may, for example, consider the contracts already accepted by the farmer and then process the amount of product that is under contract using the optimization engine. The coefficients of linear function may include the risk suggested for each farmer's crop from an AI risk model and the variables may include the amounts available to sell.

The optimization engine may use, for example, the following objective function to minimize risk:

$$Min {\sum }_{i = 1}^{N} {a}_{i} {x}_{i}$$

where aᵢ is the optimum price calculated in the profit AI model for a select crop or for multiple selected crops in a farmer profile. For example, a₁ is the price for coffee for consumer A, a₂ is the price for coffee for consumer B, a₃ is the price for corn for consumer C, xᵢ is the amount to be sold to a consumer, x₁ is the amount of coffee for consumer A, x₂ is the amount of coffee for consumer B and x₃ is the amount of coffee for consumer C. The objective function may then be subject to constraints as follows:

a₁₁x₁+a₁₂x₂+a₁₃x₃+ . . . +a₁ₙx₁ₙ≤b₁

where a₁₁ is a weight to control the amount of x₁, a₁₂ is the weight to control x₂ and a₁₃ is the weight to control x₃ until the constraint of bi is reached, for example, bi could be the amount of coffee purchased or harvested by the farmer. All amounts need to be more than 0, such that x₁, x₂, x₃ . . . ≥0.

At 318, the ranked results are provided to the user. The ranking that was created at step 218 may be transmitted to the user, for example, via an alert, an email or a text message to allow the user to store the results. The ranking may also be provided to the user in real time on a web-based application connected to a cloud-based infrastructure. The deployed AI model output provided to the user may use, for example, REST APIs to allow the data to be available to the user via a smart phone a smart tablet or a smart watch. An example AI model output may include a summary of results shown in Table 4.

TABLE 4

| | | Target | | Pro- | | |
|---|---|---|---|---|---|---|
| | | Con- | Amount | jected | | Expla- |
| Product | Type | sumer | (tons) | Profit | Risk | nation |
| Coffee | Arabic | Con- | 100 | $100,000 | medium | <click |
| | | sumer A | | | | here> |
| Coffee | Robusta | Con- | 70 | 120,000 | high | <click |
| | | sumer B | | | | here> |

At 320, the user provides feedback for further training. User feedback may be collected from a user, for example, once the ranked results are saved and the case can be scored after a time period, such as when a farmer or user harvests some crops. The user may score the predictions based on the accuracy of the result and the score provides feedback regarding the AI model predictions. For example, scoring 1-10 with 1 being predictions that were not accurate and 10 being highly accurate predictions with a section for text or type-written feedback, similar to customer reviews when purchasing items online or an emailed survey. The feedback may be monitored and analyzed for changes and the feedback may be managed for continual learning and retraining for one or more AI models created each dimension of combined dimensions.

It may be appreciated that FIGS. 2 and 3 provide only an illustration of one embodiment and do not imply any limitations with regard to how different embodiments may be implemented. Many modifications to the depicted embodiment(s) may be made based on design and implementation requirements.

FIG. 4 is a block diagram 900 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 4. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the agribusiness logistics program 110a in client computer 102, and the agribusiness logistics program 110b in network server 112, may be stored on one or more computer-readable tangible storage devices 916 for execution by one or more processors 906 via one or more RAMs 908 (which typically include cache memory). In the embodiment illustrated in FIG. 4, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the agribusiness logistics program 110a, 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the agribusiness logistics program 110a in client computer 102 and the agribusiness logistics program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the agribusiness logistics program 110a in client computer 102 and the agribusiness logistics program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure or on a hybrid cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

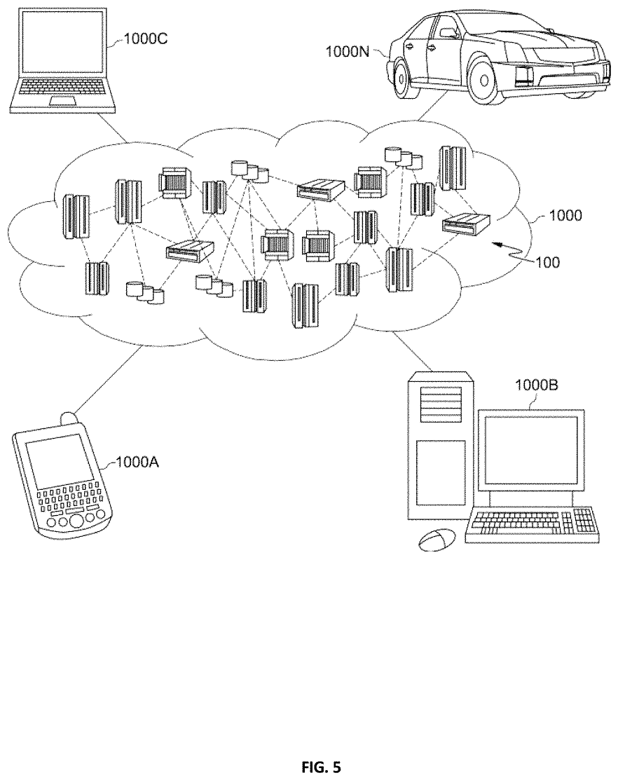

Referring now to FIG. 5, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 5 are intended to be illustrative only and that computing nodes 100 and cloud computing environment 1000 can communicate with any type of computerized device over any type of network and/or network addressable connection (e.g., using a web browser).

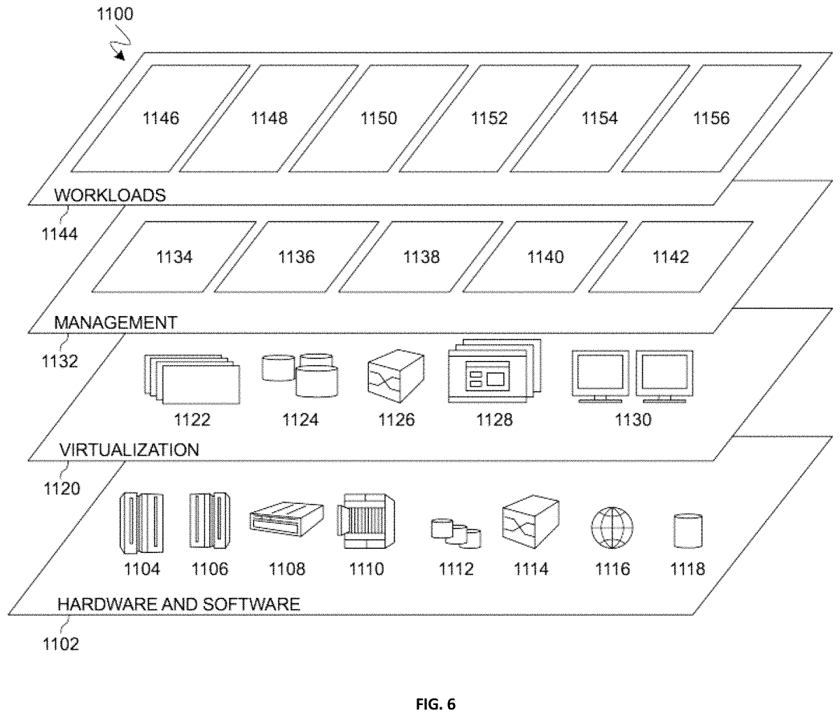

Referring now to FIG. 6, a set of functional abstraction layers 1100 provided by cloud computing environment 1000 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and agribusiness logistics 1156. A. agribusiness logistics program 110a, 110b provides a way to connect farmers and buyers with optimal logistics to get fresh products from the farm to the end consumer while reducing risk and waste.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language, python programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for an artificial intelligence (AI) based agribusiness logistics advisor, the method comprising:
receiving a first user data;
creating a first user profile;
collecting a second user data and external data;
preparing and transforming the second user data and the external data;
conducting a hypothesis on the transformed data;
validating the transformed data;
training an artificial intelligence (AI) model based on the transformed data;
validating and retraining the artificial intelligence (AI) model;
matching the first user data with the artificial intelligence (AI) model; and
ranking results based on the matching the first user data with the artificial intelligence (AI) model.

2. The method of claim 1, further comprising:
transmitting the ranked results to the first user; and
receiving feedback from the first user to provide further training to the artificial intelligence (AI) model.

3. The method of claim 1, wherein the first user data includes a name, a location of a farm, current buyer contract data, types of crops planted data, volume of products data and an estimated timing for when a product is ready for transport.

4. The method of claim 1, wherein the second user data includes buyer data, a buyer location, a product the buyer is seeking to purchase, an expected quality of the product and an expected date to receive the product.

5. The method of claim 1, wherein the external data includes information collected and received from external source databases, wherein the external data includes weather data, public service data, agriculture news data, supply chain data, logistics data, financial news data and scientific data.

6. The method of claim 1, wherein the preparing and transforming of the external data includes normalizing the second user data and the external data, creating an answer justifying document (AJD) using the normalized external data and converting the normalized external data into a machine learning model format, wherein the preparing and transforming of external data includes an advanced text analytics process, wherein the advanced text analytics process incudes multiple scorings for a plurality of products.

7. The method of claim 1, wherein the conducting the hypothesis includes building one or more scenarios based on a type of product, wherein the conducting the hypotheses is used to validate and merge conflicting data.

8. The method of claim 1, wherein the training the artificial intelligence (AI) model includes using neural networks, a subject matter expert (SME) input, supervised learning and semi-supervised learning to train the artificial intelligence (AI) model.

9. A computer system for an artificial intelligence (AI) based agribusiness logistics advisor, comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, wherein the computer system is capable of performing a method comprising:
receiving a first user data;
creating a first user profile;
collecting a second user data and external data;
preparing and transforming the second user data and the external data;
conducting a hypothesis on the transformed data;
validating the transformed data;
training an artificial intelligence (AI) model based on the transformed data;
validating and retraining the artificial intelligence (AI) model;
matching the first user data with the artificial intelligence (AI) model; and
ranking results based on the matching the first user data with the artificial intelligence (AI) model.

10. The computer system of claim 9, further comprising:
transmitting the ranked results to the first user; and
receiving feedback from the first user to provide further training to the artificial intelligence (AI) model.

11. The computer system of claim 9, wherein the first user data includes a name, a location of a farm, current buyer contract data, types of crops planted data, volume of products data and an estimated timing for when a product is ready for transport.

12. The computer system of claim 9, wherein the second user data includes buyer data, a buyer location, a product the buyer is seeking to purchase, an expected quality of the product and an expected date to receive the product.

13. The computer system of claim 9, wherein the external data includes information collected and received from external source databases, wherein the external data includes weather data, public service data, agriculture news data, supply chain data, logistics data, financial news data and scientific data.

14. The computer system of claim 9, wherein the preparing and transforming of the external data includes normalizing the second user data and the external data, creating an answer justifying document (AJD) using the normalized external data and converting the normalized external data into a machine learning model format, wherein the preparing and transforming of external data includes an advanced text analytics process, wherein the advanced text analytics process incudes multiple scorings for a plurality of products.

15. The computer system of claim 9, wherein the conducting the hypothesis includes building one or more scenarios based on a type of product, wherein the conducting the hypotheses is used to validate and merge conflicting data.

16. The computer system of claim 9, wherein the training the artificial intelligence (AI) model includes using neural networks, a subject matter expert (SME) input, supervised learning and semi-supervised learning to train the artificial intelligence (AI) model.

17. A computer program product for an artificial intelligence (AI) based agribusiness logistics advisor, comprising:
one or more computer-readable tangible storage media and program instructions stored on at least one of the one or more computer-readable tangible storage media, the program instructions executable by a processor to cause the processor to perform a method comprising:
receiving a first user data;
creating a first user profile;
collecting a second user data and external data;
preparing and transforming the second user data and the external data;
conducting a hypothesis on the transformed data;
validating the transformed data;
training an artificial intelligence (AI) model based on the transformed data;
validating and retraining the artificial intelligence (AI) model;
matching the first user data with the artificial intelligence (AI) model; and
ranking results based on the matching the first user data with the artificial intelligence (AI) model.

18. The computer program of claim 17, further comprising:
transmitting the ranked results to the first user; and
receiving feedback from the first user to provide further training to the artificial intelligence (AI) model.

19. The computer program of claim 17, wherein the first user data includes a name, a location of a farm, current buyer contract data, types of crops planted data, volume of products data and an estimated timing for when a product is ready for transport.

20. The computer program of claim 17, wherein the second user data includes buyer data, a buyer location, a product the buyer is seeking to purchase, an expected quality of the product and an expected date to receive the product.
